(19) United States
(12) Patent Application Publication
(10) Pub. No.: US 2026/0300645 A1
(43) Pub. Date: Oct. 1, 2026

(54) INFORMATION PROCESSING APPARATUS, ANALYSIS SUPPORT METHOD, AND NON-TRANSITORY RECORDING MEDIUM

(71) Applicant: NEC Corporation, Tokyo (JP)

(72) Inventors: Daisuke Matsuda, Tokyo (JP); Muneyuki Hamabe, Tokyo (JP); Shintaro Soma, Tokyo (JP)

(73) Assignee: NEC Corporation, Tokyo (JP)

(21) Appl. No.: 19/630,607

(22) Filed: Mar. 27, 2026

(30) Foreign Application Priority Data
Mar. 31, 2025 (JP) 2025-057452

(51) Int. Cl. G06F 40/40; G06T 11/26

(52) U.S. Cl. CPC G06F 40/40; G06T 11/26

(57) ABSTRACT

To facilitate analysis on various analysis targets. The information processing device includes the acceptance unit that accepts designation of an analysis target, the prompt generation unit that generates a prompt for instructing to answer information necessary for generating a report indicating an analysis result of the analysis target, the generation control unit that generates an answer by inputting the generated prompt to a generation model, and the presentation control unit that presents a report generated based on the answer. According to the information processing device, it is also possible to support decision making based on an analysis result.

### INCORPORATION BY REFERENCE

This application is based upon and claims the benefit of priority from Japanese patent application No. 2025-057452, filed on Mar. 31, 2025, the disclosure of which is incorporated herein in its entirety by reference.

### TECHNICAL FIELD

The present disclosure relates to an information processing device, an analysis support method, and an analysis support program.

### BACKGROUND ART

A tool called a digital dashboard (hereinafter, simply referred to as a dashboard) that visualizes various types of information regarding an analysis target is known. For example, JP 2024-67445 A below describes an infrastructure maintenance management support system having a function of graphically visualizing the state of the infrastructure and various maintenance-related information as a dashboard.

### SUMMARY

Although the dashboard is a useful tool for grasping the state of the analysis target and the like, there is a problem that it takes time and effort to collect various types of information regarding the state of the analysis target in order to display the dashboard. Such a problem is not limited to the dashboard, but is a problem that occurs in a report in any format indicating the analysis result of the analysis target.

The present disclosure has been made in view of the above problems, and an example object of the present disclosure is to provide a technology of facilitating analysis on various analysis targets.

An information processing device according to an example aspect of the present disclosure includes an acceptance means for accepting designation of an analysis target, a prompt generation means for generating a prompt for instructing to answer information necessary for generating a report indicating an analysis result of the analysis target, a generation control means for inputting the prompt to a machine-learned generation model so as to generate an answer to the input prompt for generating an answer, and a presentation control means for presenting a report indicating an analysis result of the analysis target generated based on the answer.

An analysis support method according to an example aspect of the present disclosure causes at least one processor to execute an acceptance process of accepting designation of an analysis target, a prompt generation process of generating a prompt for instructing to answer information necessary for generating a report indicating an analysis result of the analysis target, a generation control process of inputting a prompt to a machine-learned generation model so as to generate an answer to the input prompt and generating an answer, and a presentation control process of presenting a report indicating an analysis result of the analysis target generated based on the answer.

An analysis support program according to an example aspect of the present disclosure causes a computer to function as an acceptance means for accepting designation of an analysis target, a prompt generation means for generating a prompt for instructing to answer information necessary for generating a report indicating an analysis result of the analysis target, a generation control means for inputting the prompt to a machine-learned generation model so as to generate an answer to the input prompt and generating an answer, and a presentation control means for presenting a report indicating an analysis result of the analysis target generated based on the answer.

According to an exemplary aspect of the present disclosure, it is possible to provide a technique for facilitating analysis on various analysis targets.

### BRIEF DESCRIPTION OF DRAWINGS

The above and other aspects, features and advantages of the present disclosure will become more apparent from the following description of certain exemplary embodiments, taken in conjunction with the accompanying drawings, in which:

FIG. 1 is a block diagram illustrating a configuration of an information processing device according to the present disclosure;

FIG. 2 is a flowchart illustrating a flow of an analysis support method according to the present disclosure;

FIG. 3 is a block diagram illustrating a configuration of another information processing device according to the present disclosure;

FIG. 4 is a diagram illustrating a presentation example of a report by the information processing device illustrated in FIG. 3;

FIG. 5 is a diagram illustrating an example of a display screen displaying a list of reports relevant to a plurality of analysis targets;

FIG. 6 is a diagram illustrating an example of a display screen of a report;

FIG. 7 is a diagram illustrating a display example of relevant current event information;

FIG. 8 is a flowchart illustrating a flow of processing executed by the information processing device illustrated in FIG. 3;

FIG. 9 is a flowchart of processing related to monitoring of an analysis target; and

FIG. 10 is a block diagram illustrating a configuration of a computer that functions as the information processing device according to the present disclosure.

### EXAMPLE EMBODIMENTS

Hereinafter, example embodiments of the present invention will be exemplified. However, the present invention is not limited to each of the illustrative example embodiments described below, and various modifications can be made within a scope described in the claims. For example, example embodiments obtained by appropriately combining techniques (some or all of things or methods) adopted in each of the illustrative example embodiments described below can also be included in the scope of the present invention. Example embodiments obtained by appropriately omitting some of the techniques adopted in each of the illustrative example embodiments described below can also be included in the scope of the present invention. Effects mentioned in each of the illustrative example embodiments described below are examples of effects expected in the illustrative example embodiments, and do not define the extension of the present invention. That is, example embodiments that do not provide the effects mentioned in each of the illustrative example embodiments described below can also be included in the scope of the present invention.

### First Illustrative Example Embodiment

A first illustrative example embodiment that is an example of the example embodiments of the present invention will be described in detail with reference to the drawings. The present illustrative example embodiment is a basic form of each illustrative example embodiment to be described later. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technique illustrated in the drawings referred to for describing the present illustrative example embodiment can also be adopted in another illustrative example embodiment included in the present disclosure within a range in which no particular technical problem occurs.

### Configuration of Information Processing Device 1

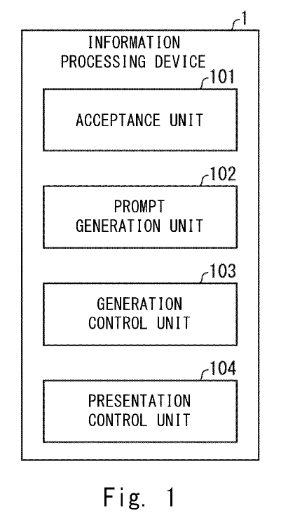

A configuration of an information processing device 1 according to the present illustrative example embodiment is described with reference to FIG. 1. FIG. 1 is a block diagram illustrating the configuration of the information processing device 1. As illustrated in FIG. 1, the information processing device 1 includes an acceptance unit 101, a prompt generation unit 102, a generation control unit 103, and a presentation control unit 104.

The acceptance unit 101 accepts designation of an analysis target. The “analysis target” may be any kind of object. For example, a product, a service, a person, an organization, a region, an industry, a field, or the like can be analyzed. For example, the acceptance unit 101 may accept direct designation such as a name of a product or the like, or may accept indirect designation such as a travel destination popular among people in their twenties, a healthcare related company, or the like.

The term “analysis” as used herein includes, in addition to “analysis” in a narrow sense that an analysis target is examined by dividing the analysis target into its components, “information collection” that collects information on the analysis target, “investigation” that examines the analysis target without dividing the analysis target into its components, and the like. Therefore, “analysis” in the present specification can also be read as “information collection” or “investigation”.

The prompt generation unit 102 generates a prompt for instructing to answer information necessary for generating a report indicating an analysis result of the designated analysis target. Here, the “prompt” is a command to be input to a generation model to be described later. Therefore, the “prompt” can be replaced with a “command”. For example, the prompt generation unit 102 generates, as the above prompt, a sentence in a natural language instructing to output information necessary for generating a report including information indicating a designated analysis target and indicating an analysis result of the analysis target. Such a prompt can be generated, for example, by incorporating information indicating an analysis target in a predetermined template.

The generation control unit 103 inputs a prompt generated by the prompt generation unit 102 into a machine-learned generation model so as to generate an answer to the input prompt, and causes the generation model to generate an answer. The “generation model” may be machine-learned so as to be able to output an answer relevant to an input prompt. What kind of generation model is used may be determined according to what kind of data format answer is generated, and the like. For example, in a case where both the input prompt and the output answer are text data of a natural language, a language model that has learned a natural language may be applied as the generation model. Here, learning a natural language more specifically means learning an arrangement of components (words and the like) in a sentence in a natural language or an arrangement of a sentence and a sentence in text. Examples of such a language model include bidirectional encoder representations from transformers (BERT), robustly optimized BERT approach (RoBERTa), efficiently learning an encoder that classifies token replacements accurately (ELECTRA), and the like. For example, it is also possible to cause the generation model to generate an image such as a graph to be a component of the report. In this case, a machine-learned generation model may be used to generate an image according to the content of the input prompt. The generation model may be obtained by fine-tuning a general-purpose generation model so that information necessary for generating a report indicating an analysis result of a designated analysis target is generated with high accuracy. In the fine tuning, data including a set of a prompt and an answer to be generated for the prompt may be used as the training data.

The above generation model may be stored in an information processing device 1 or may be stored in another device. In the latter case, the generation control unit 103 may transmit a prompt to another device and cause the another device to generate an answer, and may acquire the generated answer from the another device.

The presentation control unit 104 presents a report indicating the analysis result of the analysis target generated based on the answer generated by the generation model under the control of the generation control unit 103. Here, “presentation” means a state in which a presentation subject can recognize a presentation content. For example, the presentation control unit 104 can present a report by displaying the report on the display device. The presentation control unit 104 can present the report by making the report browsable by the subject (for example, uploading to a server accessible by the subject, or the like). The report “generated based on the answer” includes a report in which the answer generated by the generation model is used as it is, and also includes a report generated by extracting a part of the answer, performing processing as necessary, and arranging the extracted part. In a case where the report is generated using the answer generated by the generation model, the generation of the report may be performed by the information processing device 1 or may be performed by another device.

Any presentation subject can be applied. For example, a person who has designated the analysis target may be set as a presentation subject of the report, or the report may be presented to a presentation subject registered in advance. Any mode of presenting the report can also be applied. For example, the presentation control unit 104 may display the report on a terminal device used by the subject, or may present the report by printing out the report.

As described above, the information processing device 1 according to the present illustrative example embodiment employs a configuration including: the acceptance unit 101 that accepts designation of an analysis target; the prompt generation unit 102 that generates a prompt for instructing to answer information necessary for generating a report indicating an analysis result of the analysis target; the generation control unit 103 that generates an answer by inputting the generated prompt to a machine-learned generation model to generate an answer to the input prompt; and the presentation control unit 104 that presents a report indicating an analysis result of the analysis target generated based on the answer.

According to the above configuration, it is possible to present the report indicating the analysis result only by designating the analysis target. Therefore, according to the above configuration, it is possible to obtain an effect of facilitating analysis for various analysis targets. According to the information processing device 1, it is also possible to support decision making based on an analysis result.

For example, it is conceivable to use one created by a research company or the like as long as it is only to obtain analysis results such as market analysis for various analysis targets. However, since such analysis is performed only about once a year at most, it is difficult to obtain an analysis result reflecting the latest information. In this regard, by using the information processing device 1, it is possible to obtain comprehensive information regarding any analysis target at any time, to grasp the latest trend, and to obtain business awareness (for example, insight).

### Analysis Support Program

The functions of the information processing device 1 described above can also be achieved by a program. An analysis support program according to the present illustrative example embodiment causes a computer to function as: an acceptance means for accepting designation of an analysis target; a prompt generation means for generating a prompt for instructing to answer information necessary for generating a report indicating an analysis result of the analysis target; a generation control means for inputting the prompt to a machine-learned generation model so as to generate an answer to the input prompt and generating an answer; and a presentation control means for presenting a report indicating an analysis result of the analysis target generated based on the answer. According to this analysis support program, it is possible to obtain an effect of facilitating analysis on various analysis targets.

### Flow of Analysis Support Method

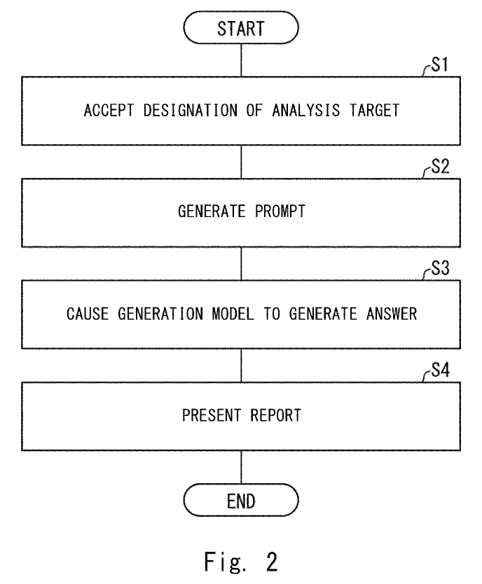

A flow of an analysis support method according to the present illustrative example embodiment will be described with reference to FIG. 2. FIG. 2 is a flowchart illustrating a flow of the analysis support method. An executing entity of each step in the analysis support method may be a processor included in the information processing device 1, may be a processor included in another device, or an executing entity of each step may be a processor provided in each of different devices.

In S1 (acceptance process), at least one processor accepts designation of an analysis target.

In S2 (prompt generation process), the at least one processor generates a prompt for instructing to answer information necessary for generating the report indicating the analysis result of the analysis target designated in S1.

In S3 (generation control process), at least one processor inputs the prompt generated in S2 into a machine-learned generation model to generate an answer to the input prompt, and causes the generation model to generate the answer.

In S4 (presentation control process), at least one processor presents a report indicating the analysis result of the analysis target generated based on the answer generated in S3.

As described above, the analysis support method according to the present illustrative example embodiment employs a configuration including: an acceptance process of accepting designation of an analysis target; a prompt generation process of generating a prompt for instructing to answer information necessary for generating a report indicating an analysis result of the analysis target; a generation control process of inputting the prompt to a machine-learned generation model to generate an answer to the input prompt and generating an answer; and a presentation control process of presenting a report indicating an analysis result of the analysis target generated based on the answer.

Therefore, according to the analysis support method of the present example embodiment, it is possible to obtain an effect of facilitating analysis on various analysis targets.

### Second Illustrative Example Embodiment

A second illustrative example embodiment that is an example of the example embodiments of the present invention will be described in detail with reference to the drawings. Components having the same functions as the components described in the above-described illustrative example embodiment are denoted by the same reference signs, and the description thereof will be appropriately omitted. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technique illustrated in each of the drawings referred to for describing the present illustrative example embodiment can be adopted in the other illustrative example embodiments included in the present disclosure within a range in which no particular technical problem occurs.

### Configuration of Information Processing Device 1A

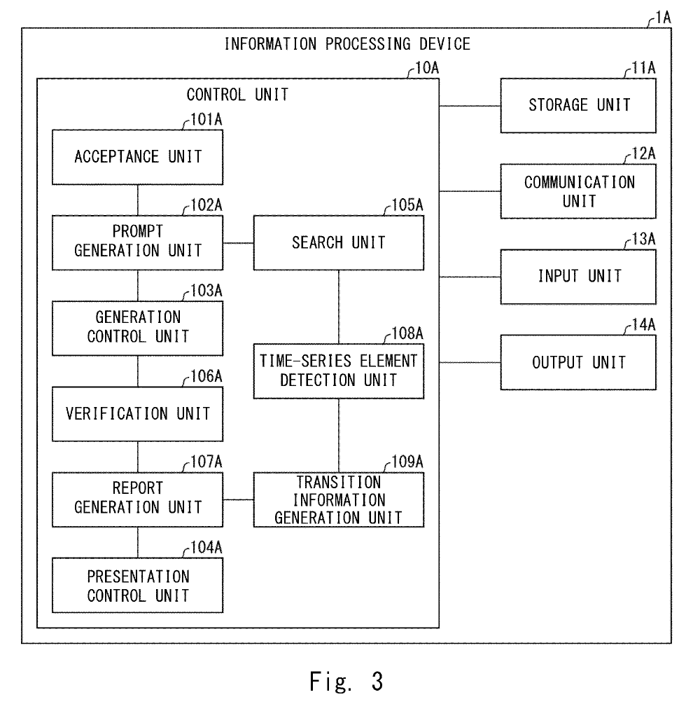

A configuration of an information processing device 1A according to the present illustrative example embodiment is described with reference to FIG. 3. FIG. 3 is a block diagram illustrating the configuration of the information processing device 1A. The information processing device 1A is a device having a function of providing an analysis support service that presents a report indicating an analysis result of a designated analysis target. The information processing device 1A may be a local device used by individual users, or may be a server that provides analysis support services to a plurality of users.

As illustrated, the information processing device 1A includes a control unit 10A that integrally controls units of the information processing device 1A and a storage unit 11A that stores various types of data to be used by the information processing device 1A. The information processing device 1A includes a communication unit 12A for the information processing device 1A to communicate with another device, an input unit 13A for accepting an input to the information processing device 1A, and an output unit 14A for the information processing device 1A to output data. Then, the control unit 10A includes an acceptance unit 101A, a prompt generation unit 102A, a generation control unit 103A, a presentation control unit 104A, a search unit 105A, a verification unit 106A, a report generation unit 107A, a time-series element detection unit 108A, and a transition information generation unit 109A. Details of the time-series element detection unit 108A and the transition information generation unit 109A will be described later in the item of “Generation of Transition Information”.

Similarly to the acceptance unit 101 of the first illustrative example embodiment, the acceptance unit 101A accepts designation of an analysis target. That any analysis target can be applied is as described in the first illustrative example embodiment. For example, the acceptance unit 101A may accept an input of a sentence representing an analysis target in a natural language. In addition to the analysis target, the acceptance unit 101A may accept designation of what the user wants to know about the analysis target (in other words, analysis item), or may accept designation of a matter to be excluded from the analysis target.

Similar to the prompt generation unit 102 of the first illustrative example embodiment, the prompt generation unit 102A generates a prompt for instructing to answer information necessary for generating a report indicating an analysis result of a designated analysis target. More specifically, the prompt generation unit 102A generates a prompt for instructing to answer a component of a report necessary for generating the report indicating the analysis result of the analysis target. For example, the prompt generation unit 102A may generate a prompt for answering an analysis result of one analysis item as one component in a report. In a case where the analysis item and items to be excluded from the analysis target are designated, the prompt generation unit 102A generates a prompt incorporating the designated contents.

Similarly to the generation control unit 103 of the first illustrative example embodiment, the generation control unit 103A generates an answer by inputting a prompt generated by the prompt generation unit 102A to a machine-learned generation model so as to generate an answer to the input prompt. As described in the first illustrative example embodiment, various models can be used as the generation model.

The generation control unit 103A may cause a plurality of answers to be generated by a plurality of generation models. In this case, the prompt generation unit 102A generates a prompt relevant to each of the plurality of generation models. For example, the prompt generation unit 102A may generate a first prompt for instructing to answer information necessary for analysis on the designated analysis item and a second prompt for instructing to generate a graph indicating an analysis result of the analysis item based on the information. In this case, the generation control unit 103A inputs the first prompt to a first generation model to answer the information necessary for analysis, and inputs the information included in the answer and the second prompt to a second generation model (machine-learned so as to generate the graph) to generate the graph. In a case where the prompt generation unit 102A generates a plurality of prompts (for example, in a case where the prompts relevant to a plurality of designated analysis items are generated), the generation control unit 103A may sequentially input the plurality of prompts to one generation model to sequentially generate answers. In the following, an example will be described in which a language model that outputs an answer in a natural language to a prompt described in the natural language is used as the above generation model.

Similarly to the presentation control unit 104 of the first illustrative example embodiment, the presentation control unit 104A presents a report indicating an analysis result of an analysis target generated based on an answer generated by a generation model under the control of the generation control unit 103A. In the present illustrative example embodiment, an example in which the presentation control unit 104A displays an analysis result on a dashboard (more precisely, a digital dashboard), that is, an example in which a report in a dashboard format is presented will be described. In the present illustrative example embodiment, an example in which the presentation control unit 104A presents a report (which can also be referred to as a dashboard) generated by the report generation unit 107A will be described.

The search unit 105A searches information related to the designated analysis target. The information acquired by the search of the search unit 105A is used for generating an answer by the generation model. As a result, information that the generation model has not learned can be reflected in the answer generated by the generation model. Details of the search by the search unit 105A will be described later in the item “Search”.

The verification unit 106A verifies whether the content of the answer is the fact by collating the answer generated by the generation model under the control of the generation control unit 103A with the collation data whose content has been confirmed to be the fact. Any verification method can be applied. For example, the verification unit 106A may perform the above verification using a machine-learned language model so as to output whether two input sentences have the same content.

The report generation unit 107A generates a report indicating the analysis result of the analysis target based on the answer generated by the generation model under the control of the generation control unit 103A. For example, the report generation unit 107A may generate the report by arranging each component included in the answer generated by the generation model on the format of the report. The report generation unit 107A may generate a report by generating components (for example, a graph or the like) of the report from the answer generated by the generation model and then arranging the components on the format of the report.

As described above, the information processing device 1A includes: the acceptance unit 101A that accepts designation of an analysis target; the prompt generation unit 102A that generates a prompt for instructing to answer information necessary for generating a report indicating an analysis result of the analysis target; the generation control unit 103A that generates an answer by inputting the generated prompt to a machine-learned generation model to generate an answer to the input prompt; and the presentation control unit 104A that presents a report indicating an analysis result of the analysis target generated based on the answer. Therefore, similarly to the information processing device 1, it is possible to obtain an effect of facilitating analysis on various analysis targets.

As described above, the information processing device 1A includes the verification unit 106A that verifies whether the content of the answer is the fact by collating the answer generated by the generation model under the control of the generation control unit 103A with the collation data for which the content has been confirmed to be the fact. Then, the presentation control unit 104A presents a report generated based on the answer whose content is determined to be the fact by the verification unit 106A. As a result, in addition to the effects obtained by the information processing device 1 according to the first illustrative example embodiment, it is possible to obtain an effect of reducing the possibility of presenting a report having contents different from the facts.

As described above, the prompt generation unit 102A generates a prompt for instructing to answer a component of a report necessary for generating the report indicating the designated analysis result of the analysis target. The information processing device 1A includes the report generation unit 107A that generates a report by arranging each component included in an answer generated by the generation control unit 103A inputting the generated prompt to the generation model. Then, the presentation control unit 104A presents the report generated by the report generation unit 107A. As a result, in addition to the effect obtained by the information processing device 1 described in the first illustrative example embodiment, it is possible to obtain an effect that a report can be generated and presented by the information processing device 1A alone.

The generation of the report is not necessarily performed by the information processing device 1A. For example, the presentation control unit 104A can also accept input of information necessary for generating a report and present the report using a service that generates a report using the information. In this case, the presentation control unit 104A may transmit the answer generated by the generation model as it is or information extracted from the answer to the service to generate a report. The processing of displaying the dashboard may also be performed by a device other than the information processing device 1A (for example, a server that provides an information presentation service by a dashboard). In this case, the presentation control unit 104A presents the dashboard to the user by transmitting various data necessary for displaying the dashboard to the device that displays the dashboard.

### Search

As described above, the search unit 105A searches information related to the designated analysis target. For example, the search unit 105A may perform search targeted for a database that records current event information and detect relevant current event information related to the analysis target. This makes it possible to present a report reflecting current events. Here, the “current event information” is information regarding current events, that is, events that occur in society at times. For example, a news article (which may be published as a moving image) published in a newspaper or an online medium, data obtained by coverage of a newspaper or the like, an explanatory article of news, a sentence, an image, or the like posted on a social networking service (SNS) or the like are examples of current event information.

The information (for example, the relevant current events information described above) detected by the search unit 105A is used for generating an answer by the generation model. Therefore, from the viewpoint of causing the generation model to generate a highly reliable answer, it is desirable to set a database in which highly reliable information is recorded as a search target. For example, a database recording current event information such as coverage data and article data generated by media that actually reports and transmits current event information such as a newspaper company may be the search target.

The search target of the search unit 105A is not limited to the above-described examples. For example, the search unit 105A may search a database in which specialized and reliable information is recorded, such as a specialized magazine in a field related to the content of the prompt. The search unit 105A may use, for example, a database in which laws and regulations are recorded as a search target. In addition, for example, the search unit 105A may search a database of an investigation company or the like that conducts a credibility investigation of a company. The search unit 105A may detect information related to the prompt (the information may be current event information or other information) by crawling on the Internet.

Any search method can also be applied. For example, the search unit 105A may extract a keyword included in the prompt and perform keyword search using the keyword. The search unit 105A may convert a part or all of the prompt into a feature vector and detect information related to the prompt by vector search using the feature vector. Furthermore, for example, the search unit 105A may use both keyword search and vector search.

As described above, the information processing device 1A includes the search unit 105A that detects relevant current event information related to an analysis target from the database that records the current event information. Then, the generation control unit 103A inputs a prompt including the detected relevant current event information to the generation model to generate an answer. For this reason, according to the information processing device 1A, in addition to the effect obtained by the information processing device 1, it is possible to obtain an effect of presenting a report in which relevant current event information related to an analysis target is reflected among current event information recorded in the database. The number of databases to be searched may be one or plural.

### Generation of Transition Information

The time-series element detection unit 108A detects a plurality of pieces of relevant current event information on the same target and having different time series from among the plurality of pieces of relevant current event information detected by the search unit 105A.

Any method of detecting a plurality of pieces of relevant current event information having different time series for the same target can be applied. For example, the time-series element detection unit 108A may first detect a plurality of pieces of relevant current event information on the same target, and detect relevant current event information having different time series from among the plurality of pieces of detected relevant current event information. Examples of a method of detecting a plurality of pieces of relevant current event information on the same target include a method of detecting relevant current event information including the same keyword. For example, it is also possible to apply a method of converting each piece of relevant current event information into a feature vector and detecting relevant current event information having similar feature vectors (the similarity of the feature vector is equal to or greater than a threshold, or the similarity of the feature vector is in a high-order predetermined number). After the plurality of pieces of relevant current event information on the same target are detected in this manner, a description (year, month, day, and the like) regarding the time series is extracted from each of the relevant current event information, and a plurality of pieces of relevant current event information having different time series may be detected based on the extracted description.

The transition information generation unit 109A generates transition information indicating the time-series change of the target based on the plurality of pieces of relevant current event information detected by the time-series element detection unit 108A. The generated transition information is included in the report and presented by the presentation control unit 104A.

The transition information may be any information as long as it can recognize the time-series change of the target indicated in the relevant current event information. For example, the transition information generation unit 109A may extract numerical values (for example, sales) related to the target from each piece of relevant current event information, and generate a sequence in which the numerical values are arranged in chronological order as the transition information. The transition information generation unit 109A may generate a numerical value (for example, a change rate), a graph, or the like obtained from the above sequence as the transition information.

As described above, the information processing device 1A includes the time-series element detection unit 108A that detects a plurality of pieces of relevant current event information on the same target, the plurality of pieces of relevant current event information being different in time series, from among the plurality of pieces of relevant current event information detected by the search unit 105A, and the transition information generation unit 109A that generates transition information indicating the time-series change of the target based on the plurality of pieces of relevant current event information detected by the time-series element detection unit 108A. Then, the presentation control unit 104A presents a report including the generated transition information. For this reason, according to the information processing device 1A, in addition to the effect obtained by the information processing device 1, it is possible to obtain an effect of being able to provide useful information such as a change in time series of the matter indicated in the relevant current event information related to the analysis target.

For example, in a case where the analysis target is a specific product, the time-series element detection unit 108A may detect a plurality of pieces of relevant current event information having different time series and described regarding the sales amount of the product from among the plurality of pieces of relevant current event information detected by the search unit 105A. In this case, the transition information generation unit 109A can generate transition information indicating a time-series change in sales of the product.

As described above, the prompt generation unit 102A may generate a prompt for instructing to answer a component of a report necessary for generating the report indicating the designated analysis result of the analysis target. In this case, a plurality of components of the report can be extracted from the answer generated by the generation model. The time-series element detection unit 108A may detect a plurality of components described for the same target and having different time series from the plurality of components. Then, the transition information generation unit 109A may generate transition information indicating the target sequence change.

For example, it is assumed that the answer generated by the generation model includes sentences (for example, a sentence describing the market size in 2023 and a sentence describing the market size in 2024) describing the market size to be analyzed and having different time series. In this case, the time-series element detection unit 108A detects these sentences. Then, the transition information generation unit 109A generates transition information indicating a time-series change in the market size to be analyzed. In this case, for example, the transition information generation unit 109A may input each detected sentence to the language model, and may generate the transition information indicating the time-series change in the market size of the analysis target.

### Example of Generation of Report

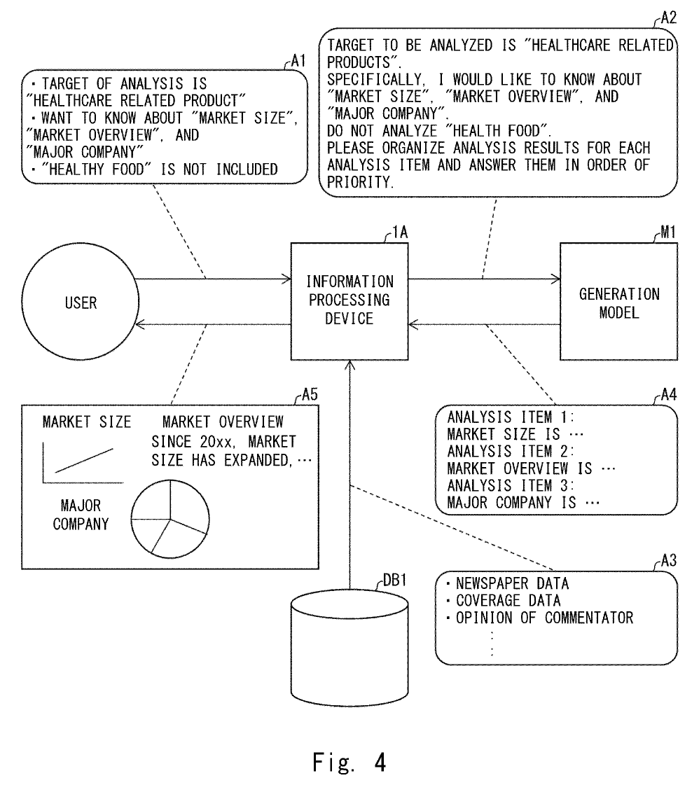

FIG. 4 is a diagram illustrating a presentation example of a report by the information processing device 1A. In the example of FIG. 4, the user of the information processing device 1A inputs, to the information processing device 1A, input data A1 that designates an analysis target. The input data A1 indicates that the analysis target is “healthcare related product”. The input data A1 indicates that the analysis items are “market size”, “market overview”, and “major company”, and indicates that “health food” is excluded from the target.

The input data A1 may be, for example, a text in a natural language. In this case, the user may input text or voice of the analysis target to the information processing device 1A. In the latter case, a text generated by causing the information processing device 1A or another device to perform voice recognition on the input voice may be acquired as the input data A1.

The acceptance unit 101A of the information processing device 1A acquires the input data A1 and passes the acquired input data A1 to the prompt generation unit 102A. Then, the prompt generation unit 102A generates a prompt for instructing to answer information necessary for generating a report indicating an analysis result of the “healthcare related product” that is the designated analysis target. In the example of FIG. 4, a prompt A2 for instructing to answer an analysis result, which includes an analysis target, an analysis item, and a matter to be excluded from the analysis target extracted from the input data A1 and is information necessary for generating a report, is generated. For example, the prompt generation unit 102A can generate the prompt A2 by incorporating information extracted from the input data A1 into a template prepared in advance.

The prompt A2 is a content instructing to organize the analysis results for each analysis item and answer in order of priority. In this manner, the prompt generation unit 102A may generate a prompt for instructing to determine the priority of the components of the report. In the example of FIG. 4, the priority is determined by outputting the analysis results for each analysis item that is a component of the report in order of priority, but a numerical value indicating the determination result of the priority or a category of the priority (for example, priority “high”, “medium”, “low”, and the like) may be output. The “priority” can also be rephrased as, for example, an importance level, an influence level, an attention level, and the like.

The prompt A2 may include information indicating the application of the answer. For example, in the case of generating a graph based on an answer to a prompt and including the generated graph in a report, a prompt for instructing to answer information for generating the graph may be used. The prompt A2 may include information indicating the purpose of the analysis. For example, by including keywords such as “market analysis” and “market research” in the prompt A2, it is possible to generate an answer suitable for “market analysis” and “market research”. In addition, for example, the prompt A2 may include information indicating who the report is for. As a result, for example, a report for ordinary employees and a report for management can be separately created for the same analysis target.

In the input data A1, the user only needs to designate at least an analysis target, and designation of an analysis item or a matter excluded from the target is not essential. In the analysis support service provided by the information processing device 1A, even if the user does not point out the analysis item, since the prompt generation unit 102A generates an appropriate prompt according to the analysis target, it is possible to present a report including the analysis result of the analysis item according to the analysis target. For example, the prompt generation unit 102A may generate a prompt for instructing to output analysis results of a plurality of analysis items to generate a report “for market analysis”. As a result, it is possible to present a report including the analysis result of the analysis item necessary for the market analysis without designating the analysis item.

Next, the search unit 105A detects relevant current event information related to the analysis target from the DB1, which is a database for recording current event information, based on the prompt A2. For example, the search unit 105A may convert the prompt A2 into a feature vector, perform vector search for the DB1 using the feature vector obtained by the conversion, and detect relevant current event information. In this case, it is desirable to record the feature vector of the current event information in the DB1 in association with each current event information. In the example of FIG. 4, newspaper data, coverage data, the opinion of the commentator, and the like (all of them are related to “healthcare related product” described as an analysis target in the prompt A2) are detected as relevant current event information A3. In addition to such data, for example, inventor relations (IR) materials, materials indicating results of previous analysis or investigation, press releases, news releases, and the like may be recorded in the DB1.

Next, the generation control unit 103A inputs the prompt A2 including the relevant current event information A3 to a generation model M1 to generate an answer. In the example of FIG. 4, an answer A4 in which the analysis results of the analysis items designated in the prompt A2 are arranged in order of their priorities is generated. The content of the answer A4 is based on the relevant current event information A3. For example, the description of the market size in the answer A4 is generated based on the description regarding the market size of the analysis target in the newspaper data or the like included in the relevant current event information A3.

Although not illustrated in FIG. 4, the verification unit 106A verifies whether the content of the answer A4 generated by the generation model M1 is the fact. The verification unit 106A may apply each piece of data recorded in the DB1, more specifically, the relevant current event information A3 used to generate the answer A4, as the collation data used for the verification and confirmed to have the content of the fact. As a result, even in a case where the answer A4 whose content is different from that of the relevant current event information A3 (that is, different from the fact) is generated, it is possible to detect the fact and prevent a report whose content is different from the fact from being presented.

For example, by generating a prompt for instructing to output the grounds of the answer together with the answer, the prompt generation unit 102A can cause the answer generated by referring to the relevant current event information to be output based on the referred relevant current event information. In this case, the verification unit 106A may verify whether the content of the answer is the fact by collating the generated answer with the relevant current event information serving as a basis for the answer.

Next, the report generation unit 107A generates a report using the answer A4 whose content is determined to be the fact by the verification unit 106A. In the example of FIG. 4, all the items included in the answer A4 are determined to be the fact, and a report A5 including all of these items is generated. In a case where the verification unit 106A determines that a part of the matters included in the answer A4 is not the fact, the report generation unit 107A generates a report using the other part obtained by excluding the part from the answer A4.

In the example of FIG. 4, the report generation unit 107A generates the report A5 by arranging the analysis result of each analysis item, which is a component of the report indicated in the answer A4, on a predetermined report format. At this time, the report generation unit 107A may arrange the analysis result indicated in the answer A4 on the report format as it is, or may acquire an image indicating the analysis result indicated in the answer A4 and arrange the acquired image instead of the analysis result. The report generation unit 107A may arrange the acquired image together with the analysis result.

The image indicating the analysis result may be, for example, transition information generated by the transition information generation unit 109A or an image generated using the transition information. The image indicating the analysis result may be, for example, an image extracted from the relevant current event information referred to at the time of generating the analysis result. The image indicating the analysis result may be generated, for example, by inputting the analysis result to a machine-learned generation model so as to generate an image relevant to the content of the input prompt.

The report A5 is a report showing analysis results of “market size”, “market overview”, and “major company”. The arrangement of these analysis results is relevant to the determination result of the priority of these analysis results by the generation model M1. That is, since the “market size” output first in the answer A4 has the highest priority, the analysis result of the “market size” is arranged in the upper left corner that is most noticeable in the report A5. The analysis result of the “market overview” with the second priority output second in the answer A4 is arranged in the upper right corner of the report A5, and the analysis result of the “major company” with the third priority output third in the answer A4 is arranged below the analysis results of the “market size” and the “market overview”.

As described above, the prompt generation unit 102A may generate a prompt for instructing to answer a component of a report necessary for generating the report indicating the analysis result of the analysis target and to determine the priority of the component. Then, the report generation unit 107A may generate a report in which components with high priority are preferentially arranged. As a result, in addition to the effect obtained by the information processing device 1, an effect that the user can easily recognize the analysis result with high priority can be obtained.

Here, “preferentially arranged” means that a component having a higher priority is arranged so as to be more easily recognized by the user than a component having a lower priority. For example, the report format may be divided into a plurality of areas in advance, and each area may be ranked in order of being easily noticed by the user. In this case, the report generation unit 107A may arrange the components in descending order of priority in the areas of higher rank. The report generation unit 107A may arrange the components in a mode of arranging the components from the top in order of priority or arranging only items with high priority.

### Designation of a plurality of analysis targets

The acceptance unit 101A can accept designation of a plurality of analysis targets at one time or sequentially. In this case, a report of each analysis target is generated. In a case where a plurality of reports are generated, the presentation control unit 104A may display a list of the generated reports to be analyzed, and may display details of a report selected by the user among the displayed list of reports.

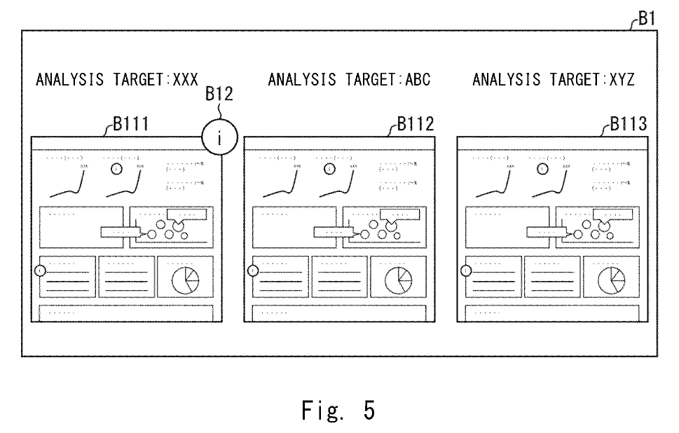

FIG. 5 is a diagram illustrating an example of a display screen displaying a list of reports relevant to each of a plurality of analysis targets. In a screen example B1 illustrated in FIG. 5, a reduced version of the report generated for “XXX” to be analyzed is displayed as a selection item B111. In the screen example B1, reduced versions of the reports generated for “ABC” and “XYZ” to be analyzed are displayed as selection items B112 and B113. The user can display a report (not a reduced version but a report of a normal size) relevant to the selection item by performing an operation of selecting any one of the selection items B111 to B113.

An update mark B12 is displayed in association with the selection item B111. The update mark B12 is a display object indicating that the content of the report has been updated. Although details will be described later, the information processing device 1A can also monitor an analysis target. It is possible to easily monitor a plurality of analysis targets by displaying a list of the reports of the analysis targets being monitored or the selection items relevant to the reports and notifying, by the update mark B12, that the contents of the report have been updated.

The presentation control unit 104A may present information related to the content of each report together with the report. For example, the presentation control unit 104A may extract words included in each report, generate a word cloud, and present the generated word cloud together with the report. As a result, a keyword to be noted in each report can be recognized before the report is read. The word cloud is obtained by displaying each word included in the target document in a font size according to the appearance frequency. The word cloud may be generated by the presentation control unit 104A, or may be generated by a device other than the information processing device 1A.

### Display Example of Report

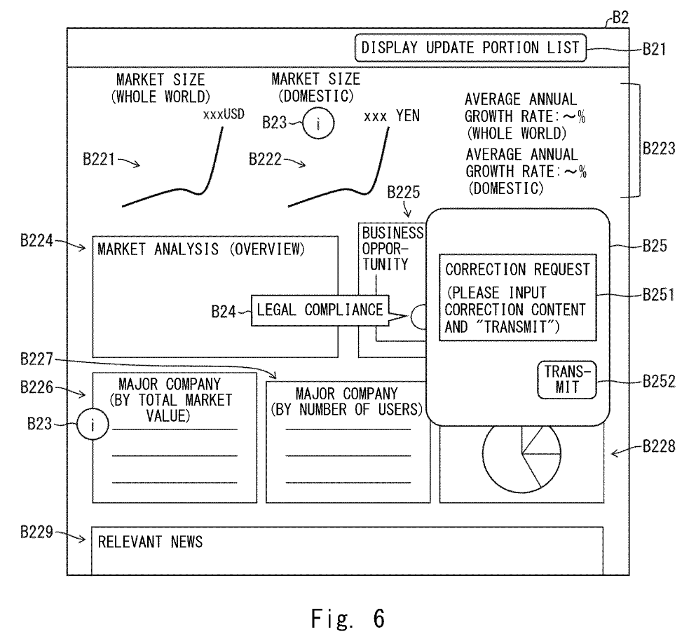

FIG. 6 is a diagram illustrating an example of a display screen of a report. In a screen example B2 illustrated in FIG. 6, an update portion list display button B21 is displayed. As described above, the information processing device 1A can monitor the analysis target, and the report is updated as needed for the analysis target being monitored. The update portion list display button B21 is a display object for displaying a list of update portions in the report. In a case where an operation of selecting the update portion list display button B21 is performed, the presentation control unit 104A displays a list of update portions in the report.

In the screen example B2, the analysis result is displayed for each of the plurality of analysis items. Specifically, in the screen example B2, as the analysis results of the market size, a graph B221 showing the transition of the market size in the whole world, a graph B222 showing the transition of the market size in Japan, and an average annual growth rate B223 of the market size in the whole world and in Japan are displayed. In this manner, it is also possible to present a plurality of analysis results for one analysis item.

The graphs B221 and B222 may be generated by the transition information generation unit 109A or may be extracted from relevant current event information. The same applies to the average annual growth rate B223. The average annual growth rate B223 can also be calculated from the graphs B221 and B222 or numerical data that is the basis thereof.

An update mark B23 is displayed in association with the graph B222. The update mark B23 indicates that the graph B222 has been updated. As described above, in a case where there is an update to any analysis item of the analysis target being monitored, the presentation control unit 104A may display the update mark B23 on the updated analysis item in the report to clearly indicate that the analysis item has been updated.

In the screen example B2, an explanatory sentence B224 of the market overview is displayed as an analysis result of the market overview. The explanatory sentence B224 may be generated by the generation model based on, for example, relevant current event information. A graph B225 indicating an analysis result of the business opportunity is displayed on the screen example B2. The graph B225 may be generated by the report generation unit 107A or may be extracted from relevant current event information.

An annotation comment B24 is displayed in association with the graph B225. The annotation comment B24 is a display object indicating a portion to be noted in the analysis result. The annotation comment B24 can be generated by the generation model. For example, the prompt generation unit 102A may generate a prompt for instructing to answer the analysis result of the analysis target, and instructing to extract a particularly notable part in the analysis result and answer a comment on the part. By inputting such a prompt to the generation model, it is possible to cause the generation model to generate an answer including content to be presented as the annotation comment.

In the screen example B2, major company lists B226 and B227 and a graph B228 indicating a classification result of the category of the major company are displayed as the analysis result of the major company. The major company lists B226 and B227 may be extracted from, for example, relevant current event information. The report generation unit 107A can also display the major company lists B226 and B227 by arranging the major companies included in the answers of the generation model in a predetermined standard (in the order of the total market value if B226, and in the order of the number of users if B227). The graph B228 may also be extracted from the relevant current event information or may be generated based on the answer of the generation model.

The screen example B2 includes a display field B229 for displaying relevant news related to the analysis result of each analysis item. For example, the report generation unit 107A may cause the display field B229 to display the relevant current event information used for generating the answer by the generation model as the relevant news.

A correction acceptance window B25 is superimposed and displayed on the screen example B2. The correction acceptance window B25 includes an input field B251 and a transmission button B252. The user inputs an item to be corrected in the report in the input field B251 and operates the transmission button B252. As a result, the user's correction request is accepted by the acceptance unit 101A, and the report is updated.

Here, as described above, the generation model used for generating the report may be a language model obtained by machine learning of a natural language. In this case, the acceptance unit 101A may accept feedback in a natural language regarding the content of the presented report. In a case where the acceptance unit 101A accepts the feedback, the prompt generation unit 102A generates a new prompt that includes the content of the accepted feedback and instructs to answer information necessary for generating the report indicating the analysis result of the analysis target. Next, the generation control unit 103A inputs the generated new prompt to the generation model to generate a new answer. Then, the presentation control unit 104A presents a report updated based on the new answer, that is, a report reflecting the feedback of the user. As a result, in addition to the effect obtained by the information processing device 1, it is possible to easily reflect the intention of the user in the report.

For example, it is assumed that the user inputs “please explain the legal compliance in the analysis result of the business opportunity in detail” in the input field B251 and operates the transmission button B252. In this case, the acceptance unit 101A accepts this sentence as feedback from the user and delivers the sentence to the prompt generation unit 102A. Next, the prompt generation unit 102A generates a new prompt by adding the above sentence to the latest prompt (for example, the prompt A2 shown in FIG. 4) generated for the report to be corrected. The generation control unit 103A inputs this new prompt to the generation model to generate a new answer. This answer includes a detailed description of legal compliance. Next, the report generation unit 107A updates the report using the generated new answer, and the presentation control unit 104A presents the updated report. The presentation control unit 104A may notify the updated portion in the report, for example, by displaying the update mark B23 illustrated in FIG. 6.

The feedback of the user is not limited to one that requests to supplement the content of the report as in the above example. For example, in addition to an instruction to correct the content of the report, the acceptance unit 101A can also accept an instruction to change a viewpoint of analysis or an analysis item, an instruction to change an output format such as an instruction to replace a description in sentences with an image indicating the description content, an instruction to change arrangement of each component in the report, an instruction to change a presentation subject (for example, for general employees/management staff, etc.) of the report, and the like.

### Presentation of Relevant Current Event Information on which Analysis Result is based

Here, as in the screen example B2 of FIG. 6, in a case where the respective analysis results and the relevant news, that is, the relevant current event information on which the respective analysis results are based are displayed in different regions, it is conceivable that the user has difficulty in recognizing the correspondence between the respective analysis results and the relevant current event information on which the respective analysis results are based. For this reason, the presentation control unit 104A may display each analysis result and the relevant current event information based on the analysis result in association with each other.

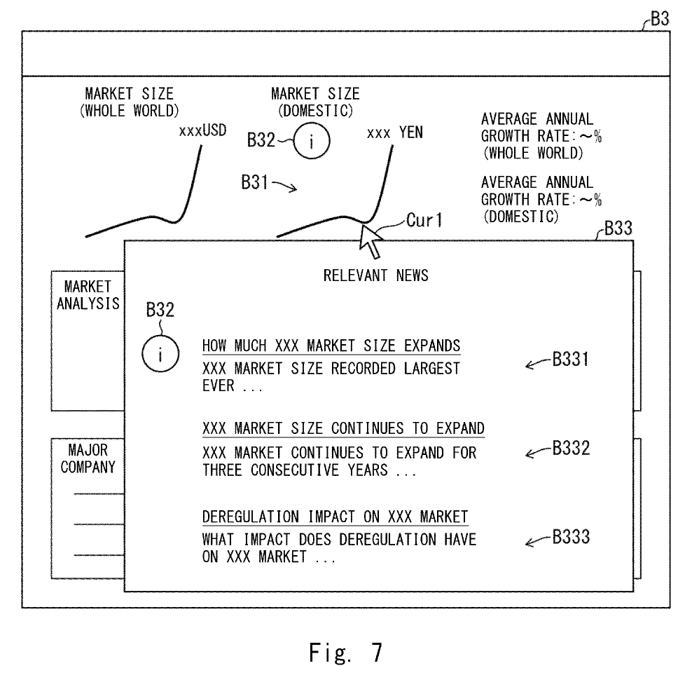

The presentation control unit 104A may display the relevant current event information used to obtain the analysis result displayed on the display portion in response to a predetermined operation on the display portion of the analysis result in the report. This will be described with reference to FIG. 7. FIG. 7 is a diagram illustrating a display example of relevant current event information.

Similarly to the screen example B2 of FIG. 6, a screen example B3 illustrated in FIG. 7 displays a report including the analysis result of each analysis item such as the market size. The screen examples B3 and B2 are different in that the screen example B3 does not include the display field B229 for displaying relevant news.

Here, in the example of FIG. 7, a cursor Cur1 is aligned with a graph B31 indicating the analysis result of the domestic market size among the displayed analysis results. Then, in the example of FIG. 7, a pop-up screen B33 indicating relevant news on which the graph B31 is based, that is, relevant current event information is displayed according to the operation of aligning the cursor Cur1 to the graph B31. The pop-up screen B33 displays headlines B331 to B333 indicating the relevant current event information on which the graph B31 is based.

That is, in the example of FIG. 7, the presentation control unit 104A displays the relevant current event information used to generate the graph B31 in response to the operation of aligning the cursor Cur1 to the graph B31 in the report illustrated in the screen example B3. As a result, the user can confirm the relevant current event information by an intuitive and simple operation of aligning the cursor Cur1 to the analysis result on which the user wants to confirm the relevant current event information. Any operation of displaying the relevant current event information can be applied and is not limited to the example of FIG. 7.

In the screen example of FIG. 7, an update mark B32 is displayed in association with the graph B31. Then, among the headlines B331 to B333 displayed on the pop-up screen B33, the update mark B32 is also displayed in association with the headline B331. In this manner, the presentation control unit 104A may display the relevant current event information that has caused the analysis result to be updated in a distinguishable manner from other relevant current event information. As a result, it is possible to allow the user to easily recognize the relevant current event information that has caused the analysis result to be updated.

### Flow of Processing

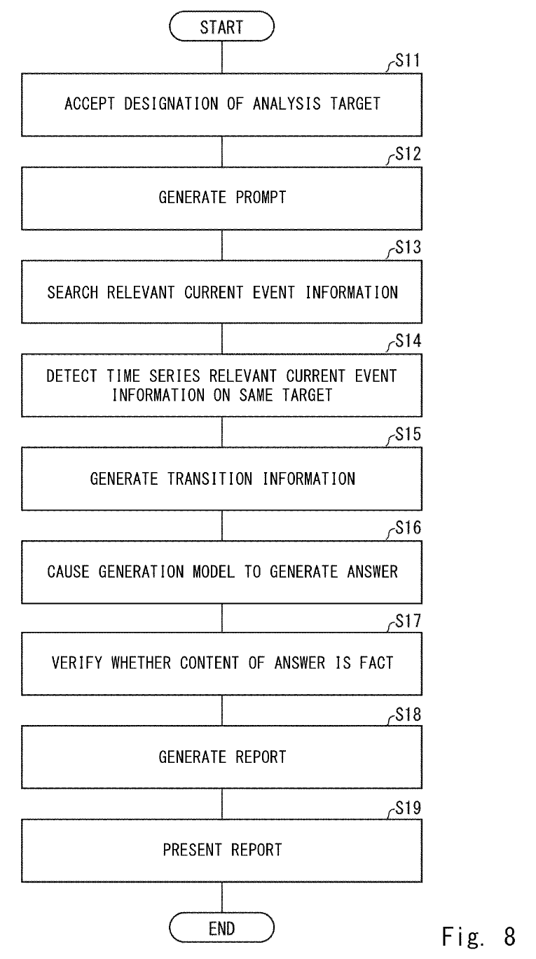

A flow of processing executed by the information processing device 1A will be described with reference to FIG. 8. FIG. 8 is a flowchart illustrating a flow of processing executed by the information processing device 1A. The flowchart of FIG. 8 includes each processing of the analysis support method according to the present illustrative example embodiment.

In S11 (acceptance process), the acceptance unit 101A accepts designation of an analysis target. For example, the acceptance unit 101A may accept, via the communication unit 12A, designation of an analysis target input by the user of the analysis support service to the terminal device operated by the user. The acceptance unit 101A may accept designation of an analysis target via the input unit 13A. In S11, the acceptance unit 101A may also accept designation of an analysis item or designation of an item to be excluded from the analysis target, for example.

In S12 (prompt generation process), the prompt generation unit 102A generates a prompt for instructing to answer information necessary for generating the report indicating the analysis result of the analysis target designated in S11. For example, the prompt generation unit 102A may generate a prompt for instructing to answer a component of a report necessary for generating the report indicating the analysis result designated in S11 of the analysis target.

In S13, the search unit 105A searches a plurality of pieces of relevant current event information related to the analysis target using the prompt generated in S12. In S13, information other than the current event information may also be set as the search target. The processing of S13 may be performed before S12.

In this case, the prompt generation unit 102A generates a prompt by using the relevant current event information detected by the search.

In S14, the time-series element detection unit 108A detects a plurality of pieces of relevant current event information on the same target and having different time series from among the plurality of pieces of relevant current event information detected in S13. For example, in a case where the analysis item includes “market size”, the time-series element detection unit 108A may detect a plurality of pieces of relevant current event information (for example, news articles) that are described about the market size of the analysis target designated in S11 and have different time series. In a case where the relevant current event information is not detected in S14, the process proceeds to S16 without performing the process of S15.

In S15, the transition information generation unit 109A generates transition information indicating the time-series change of the target based on the plurality of pieces of relevant current event information detected in S14. For example, in a case where a plurality of pieces of relevant current event information having different time series described about the market size of the analysis target is detected in S14, the transition information generation unit 109A generates transition information (for example, a graph, a sequence, a numerical value, or a sentence) indicating a time-series change in the market size of the analysis target. A generation model may be used to generate the transition information. The generation model used in S16 may be used, or a generation model different from the generation model used in S16 may be used.

In S16 (generation control process), the prompt generated in S12 is input to the generation model together with the relevant current event information detected in S13, and an answer is generated. In performing the processing of S16, the prompt generation unit 102A may regenerate the prompt by using the relevant current event information detected in S13.

In S17, the verification unit 106A verifies whether the content of the answer is the fact by collating the answer generated in S16 with the collation data whose content has been confirmed to be the fact. The verification in S17 is performed for each component of the report (specifically, the analysis result of each analysis item) included in the answer generated in S16.

In S18, the report generation unit 107A arranges each component included in the answer generated in S16 on the format of the report to generate the report. The report generation unit 107A generates a report using a component whose content is determined to be factual in S17 among the components included in the answer generated in S16, and does not include the component determined not to be factual in the report. The report generation unit 107A includes the transition information generated in S15 in the report as it is or after processing such as graphing is performed.

In S19 (presentation control process), the presentation control unit 104A presents the report indicating the analysis result of the analysis target generated based on the report generated in S18, that is, the answer generated under the control in S16. As a result, the processing in FIG. 8 ends. In S18, the report generation unit 107A may generate a report in a dashboard format. In this case, in S19, the presentation control unit 104A displays the analysis result on the dashboard.

### Monitoring of Analysis Target

As described above, the information processing device 1A can also monitor the analysis target. In this case, the search unit 105A searches the relevant current event information every time a predetermined search timing arrives. Here, in a case where the new relevant current event information is detected by the search unit 105A, the prompt generation unit 102A generates a new prompt for instructing to answer information necessary for generating the report indicating the analysis result of the analysis target by using the new relevant current event information. Then, the generation control unit 103A inputs the generated new prompt to the generation model to generate a new answer, and the presentation control unit 104A presents a report updated based on the generated new answer. As a result, in addition to the effect obtained by the information processing device 1, it is possible to easily perform continuous monitoring of the analysis target. This makes it possible to immediately alert the change in the analysis target. For example, in a case where a market of a predetermined product or service is set as an analysis target, a change point of the market can be notified.

In order to reflect the latest news and the like in the report, it is desirable to record the latest news and the like as needed also in the database as the search target of the search unit 105A. It is also effective to include a web page such as a news site on which the latest news and topics are posted in the search target of the search unit 105A.

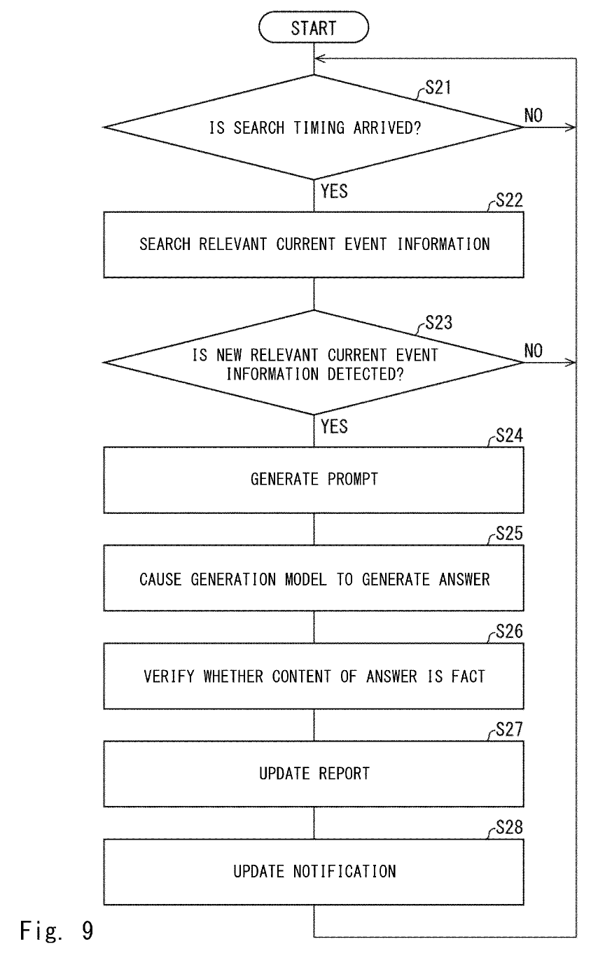

FIG. 9 is a flowchart of processing related to monitoring of an analysis target. The processing of FIG. 9 is performed, for example, after the execution of the processing of FIG. 8 is completed.

In S21, the search unit 105A determines whether a predetermined search timing has come. In a case where YES is determined in S21, the process proceeds to S22, and in a case where NO is determined in S21, the process of S21 is performed again after a predetermined time. The search timing may be determined in advance. For example, the timing at which the database as the search target of the search unit 105A is updated may be set as the search timing, or the timing at which a predetermined period (for example, one day) has elapsed from the previous search may be set as the search timing.

In S22, the search unit 105A searches relevant current event information. The search of the relevant current event information may be performed in the same manner as in S13 of FIG. 8. Even if the search method and the search condition are the same as those of the previous search, if the database or the like as the search target of the search unit 105A is updated, new relevant current event information can be detected. In the second and subsequent searches, the previous search and the search condition may be changed.

In S23, the search unit 105A determines whether new relevant current event information has been detected by the search in S22. The new relevant current event information is relevant current event information that has not been detected until the previous search. In a case where YES is determined in S23, the process proceeds to S24. On the other hand, if NO is determined in S23, the processing returns to S21.

In S24, the prompt generation unit 102A generates a new prompt for instructing to answer information necessary for generating the report indicating the analysis result of the analysis target by using the new relevant current event information detected in the search in S22. For example, the prompt generation unit 102A may generate a prompt for instructing to answer information necessary for generating a report indicating an analysis result of the analysis target, the information including new relevant current event information detected by the search in S22, with reference to the new relevant current event information. The prompt generation unit 102A may generate a prompt including detected new relevant current event information and instructing to update the previous answer based on the new relevant current event information. The “previous answer” is the answer generated in S16 of FIG. 8 in a case where the report is updated for the first time, and is the answer used for the latest update in a case where the report is updated for the second and subsequent times.

In S25, the generation control unit 103A inputs the new prompt generated in S24 to the generation model and generates a new answer. Subsequently, in S26, the verification unit 106A verifies whether the content of the answer generated in S25 is the fact.

In S27, the report generation unit 107A updates the report using components whose contents are determined to be factual in S26 among the components of the report included in the answer generated in S25. It is not always necessary to use all the components whose contents are determined to be the facts in S26 for the update, and among the components whose contents are determined to be the facts in S26, the components whose contents have been updated may be used for the update.

In S28, the presentation control unit 104A notifies the user that the report has been updated. Thereafter, the process proceeds to S21. Any notification mode in S28 can be applied. For example, as in the screen example B1 of FIG. 5, the update may be notified by displaying the update mark B12 in association with the updated report. The presentation control unit 104A may notify the update, for example, by e-mail or the like.

### Modified Examples

In the second illustrative example embodiment, an example has been described in which a prompt for instructing to answer a component of a report indicating an analysis result to be analyzed is generated, and each component included in the generated answer is arrayed by inputting the prompt to the generation model to generate a report. However, the method of generating the report is not limited to this example. For example, the prompt generation unit 102A of the second illustrative example embodiment may generate a prompt for instructing to generate a report in which analysis results for each analysis item to be analyzed are arranged. In this case, since the report in which each analysis result is arranged is output from the generation model, the presentation control unit 104A may present the output report. It is also possible to automatically generate a report in which analysis results with high priority are arranged in a conspicuous manner by including a sentence instructing to arrange the analysis results for each analysis item in order of priority in the above prompt.

An executing entity of each processing described in the above-described illustrative example embodiments is optional, and is not limited to the above-described examples. For example, a system having functions similar to those of the information processing devices 1 and 1A can be constructed by a plurality of devices capable of communicating with each other. The execution subject of each processing illustrated in each of the flowcharts illustrated in FIGS. 8 and 9 may be one device (also referred to as a processor) or a plurality of devices (also referred to as a processor).

### Implementation Example by Software

Some or all functions of the information processing devices 1 and 1A (hereinafter, also referred to as “each of the above devices”) may be implemented by hardware such as an integrated circuit (IC chip) or may be implemented by software.

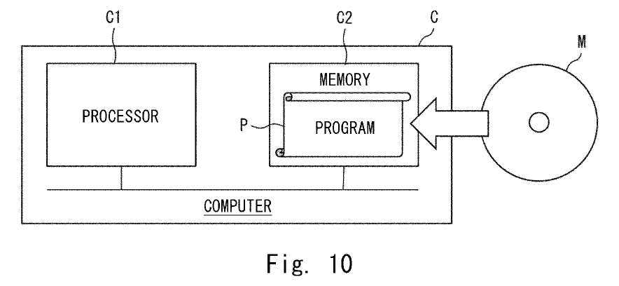

In the latter case, each of the above devices is achieved by, for example, a computer that executes commands of a program that is software for implementing each function. An example of such a computer (hereinafter, referred to as computer C) is illustrated in FIG. 10. FIG. 10 is a block diagram illustrating a hardware configuration of the computer C that functions as each of the above devices.

The computer C includes at least one processor C1 and at least one memory C2. A program P for causing the computer C to operate as each of the above devices is recorded in the memory C2. In the computer C, by the processor C1 reading the program P from the memory C2 and executing the program P, each function of each of the above devices is implemented.

Examples of the processor C1 include, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, and a combination thereof. Examples of the memory C2 may include a flash memory, a Hard Disk Drive (HDD), a Solid State Drive (SSD), and a combination thereof.

The computer C may further include a Random Access Memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, a printer, and the like.

The program P may be recorded in a non-transitory tangible recording medium M readable by the computer C. As such a recording medium M, for example, a tape, a disk, a card, a semiconductor memory, a programmable logic circuit, or the like can be used.

The computer C can acquire the program P via such a recording medium M. The program P can be transmitted via a transmission medium. As such a transmission medium, for example, a communication network, a broadcast wave, or the like can be used. The computer C may also obtain the program P via such a transmission medium.

Each of the above functions of each of the above devices may be implemented by a single processor provided in a single computer, may be implemented in cooperation with a plurality of processors provided in a single computer, or may be implemented in cooperation with a plurality of processors provided in a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in a plurality of computers.

### Supplementary Information

The present disclosure includes the techniques described in the following Supplementary Notes. However, the present invention is not limited to the technologies described in the following Supplementary Notes, and various modifications can be made within the scope described in the claims.

### SUPPLEMENTARY NOTE A1

An information processing device including: an acceptance means for accepting designation of an analysis target; a prompt generation means for generating a prompt for instructing to answer information necessary for generating a report indicating an analysis result of the analysis target; a generation control means for inputting the prompt to a machine-learned generation model so as to generate an answer to the input prompt for generating an answer; and a presentation control means for presenting a report indicating an analysis result of the analysis target generated based on the answer.

### Supplementary Note A2

The information processing device according to Supplementary Note A1, including a search means for detecting relevant current event information related to the analysis target from a database in which the current event information is recorded, in which the generation control means inputs a prompt including the relevant current event information to the generation model to generate an answer.

### Supplementary Note A3

The information processing device according to Supplementary Note A2, in which the search means searches the relevant current event information every time a predetermined search timing arrives, the prompt generation means generates a new prompt for instructing to answer information necessary for generating a report indicating an analysis result of the analysis target by using the new relevant current event information in a case where the new relevant current event information is detected by the search means, the generation control means inputs the new prompt to the generation model to generate a new answer, and the presentation control means presents a report updated based on the new answer.

### Supplementary Note A4

The information processing device according to any one of Supplementary Notes A1 to A3, including a verification means for verifying whether a content of an answer generated by the generation model is a fact by collating the answer with collation data whose content has been confirmed to be a fact, in which the presentation control means presents a report generated based on an answer whose content is determined to be a fact by the verification means.

### Supplementary Note A5

The information processing device according to Supplementary Note A2, in which the generation model is a language model obtained by machine learning of a natural language, the acceptance means accepts feedback in a natural language regarding a content of the presented report, the prompt generation means generates a new prompt that includes a content of the feedback and instructs to answer information necessary for generating a report indicating an analysis result of the analysis target, the generation control means inputs the new prompt to the generation model to generate a new answer, and the presentation control means presents a report updated based on the new answer.

### Supplementary Note A6

The information processing device according to any one of Supplementary Notes A1 to A5, in which the prompt generation means generates a prompt for instructing to answer a component of a report necessary for generating the report indicating an analysis result of the analysis target, the information processing device comprises a report generation means for generating a report by arranging each component included in an answer generated by the generation control means inputting the prompt to the generation model, and the presentation control means presents the report generated by the report generation means.

### Supplementary Note A7

The information processing device according to Supplementary Note A6, in which the prompt generation means generates a prompt for instructing to answer a component of a report necessary for generating the report indicating an analysis result of the analysis target and to determine a priority of the component, and the report generation means generates a report in which the component having a high priority is preferentially arranged.

### Supplementary Note A8

The information processing device according to Supplementary Note A2 or A3, including: a time-series element detection means for detecting a plurality of pieces of relevant current event information on a same target, the plurality of pieces of relevant current event information having different time series, from among a plurality of pieces of relevant current event information detected by the search means; and a transition information generation means for generating transition information indicating a time-series change of the target based on the plurality of pieces of relevant current event information detected by the time-series element detection means, in which the presentation control means presents the report including the transition information.

### Supplementary Note B1

An analysis support method for causing at least one processor to execute: an acceptance process of accepting designation of an analysis target; a prompt generation process of generating a prompt for instructing to answer information necessary for generating a report indicating an analysis result of the analysis target; a generation control process of inputting a prompt to a machine-learned generation model so as to generate an answer to the input prompt and generating an answer; and a presentation control process of presenting a report indicating an analysis result of the analysis target generated based on the answer.

### Supplementary Note B2

The analysis support method according to Supplementary Note B1, in which the at least one processor executes a search process of detecting relevant current event information related to the analysis target from a database in which current event information is recorded, and the at least one processor is configured to input, in the generation control process, a prompt including the relevant current event information to the generation model to generate an answer.

### Supplementary Note B3

The analysis support method according to Supplementary Note B2, in which the at least one processor is configured to search the relevant current event information every time a predetermined search timing arrives, a new prompt is generated for instructing to answer information necessary for generating a report indicating an analysis result of the analysis target by using the new relevant current event information in a case where the new relevant current event information is detected by the search process, the new prompt is input to the generation model to generate a new answer, and a report updated based on the new answer is presented.

### Supplementary Note B4

The analysis support method according to any one of Supplementary Notes B1 to B3, in which the at least one processor executes a verification process of verifying whether a content of an answer generated by the generation model is a fact by collating the answer with collation data whose content has been confirmed to be a fact, and the at least one processor presents, in the presentation control process, a report generated based on an answer whose content is determined to be a fact by the verification process.

### Supplementary Note B5

The analysis support method according to Supplementary Note B2, in which the generation model is a language model obtained by machine learning of a natural language, and the at least one processor is configured to: accept feedback in a natural language regarding a content of the presented report; generate a new prompt that includes a content of the feedback and instructs to answer information necessary for generating a report indicating an analysis result of the analysis target; input the new prompt to the generation model to generate a new answer; and present a report updated based on the new answer.

### Supplementary Note B6

The analysis support method according to any one of Supplementary Notes B1 to B5, in which the at least one processor is configured to generate, in the prompt generation process, a prompt for instructing to answer a component of a report necessary for generating the report indicating an analysis result of the analysis target, the at least one processor executes a report generation process of generating a report by arranging each component included in an answer generated by the generation control process inputting the prompt to the generation model, and the at least one processor is configured to present, in the presentation control process, the report generated by the report generation process.

### Supplementary Note B7

The analysis support method according to Supplementary Note B6, in which the at least one processor is configured to generate, in the prompt generation process, a prompt for instructing to answer a component of a report necessary for generating the report indicating an analysis result of the analysis target and to determine a priority of the component, and the at least one processor is configured to generate, in the report generation process, a report in which the component having a high priority is preferentially arranged.

### Supplementary Note B8

The analysis support method according to Supplementary Note B2 or B3, in which the at least one processor executes: a time-series element detection process of detecting a plurality of pieces of relevant current event information on a same target, the plurality of pieces of relevant current event information having different time series, from among a plurality of pieces of relevant current event information detected by the search process; and a transition information generation process of generating transition information indicating a time-series change of the target based on the plurality of pieces of relevant current event information detected by the time-series element detection process, and the at least one processor is configured to present, in the presentation control process, the report including the transition information.

### Supplementary Note C1

An analysis support program for causing a computer to function as: an acceptance means for accepting designation of an analysis target; a prompt generation means for generating a prompt for instructing to answer information necessary for generating a report indicating an analysis result of the analysis target; a generation control means for inputting the prompt to a machine-learned generation model so as to generate an answer to the input prompt for generating an answer; and a presentation control means for presenting a report indicating an analysis result of the analysis target generated based on the answer.

### Supplementary Note C2

The analysis support program according to Supplementary Note C1, in which the computer is caused to function as a search means for detecting relevant current event information related to the analysis target from a database in which the current event information is recorded, and the generation control means inputs a prompt including the relevant current event information to the generation model to generate an answer.

### Supplementary Note C3

The analysis support program according to Supplementary Note C2, in which the search means searches the relevant current event information every time a predetermined search timing arrives, the prompt generation means generates a new prompt for instructing to answer information necessary for generating a report indicating an analysis result of the analysis target by using the new relevant current event information in a case where the new relevant current event information is detected by the search means, the generation control means inputs the new prompt to the generation model to generate a new answer, and the presentation control means presents a report updated based on the new answer.

### Supplementary Note C4

The analysis support program according to any one of Supplementary Notes C1 to C3, in which the computer is caused to function as a verification means for verifying whether a content of an answer generated by the generation model is a fact by collating the answer with collation data whose content has been confirmed to be a fact, and the presentation control means presents a report generated based on an answer whose content is determined to be a fact by the verification means.

### Supplementary Note C5

The analysis support program according to Supplementary Note C2, in which the generation model is a language model obtained by machine learning of a natural language, the acceptance means accepts feedback in a natural language regarding a content of the presented report, the prompt generation means generates a new prompt that includes a content of the feedback and instructs to answer information necessary for generating a report indicating an analysis result of the analysis target, the generation control means inputs the new prompt to the generation model to generate a new answer, and the presentation control means presents a report updated based on the new answer.

### Supplementary Note C6

The analysis support program according to any one of Supplementary Notes C1 to C5, in which the prompt generation means generates a prompt for instructing to answer a component of a report necessary for generating the report indicating an analysis result of the analysis target, the computer is caused to function as a report generation means for generating a report by arranging each component included in an answer generated by the generation control means inputting the prompt to the generation model, and the presentation control means presents the report generated by the report generation means.

### Supplementary Note C7

The analysis support program according to Supplementary Note C6, in which the prompt generation means generates a prompt for instructing to answer a component of a report necessary for generating the report indicating an analysis result of the analysis target and to determine a priority of the component, and the report generation means generates a report in which the component having a high priority is preferentially arranged.

### Supplementary Note C8

The analysis support program according to Supplementary Note C2 or C3, in which the computer is caused to function as: a time-series element detection means for detecting a plurality of pieces of relevant current event information on a same target, the plurality of pieces of relevant current event information having different time series, from among a plurality of pieces of relevant current event information detected by the search means; and a transition information generation means for generating transition information indicating a time-series change of the target based on the plurality of pieces of relevant current event information detected by the time-series element detection means, in which the presentation control means presents the report including the transition information.

### Supplementary Note D1

An information processing device including at least one processor, in which the at least one processor executes: an acceptance process of accepting designation of an analysis target; a prompt generation process of generating a prompt for instructing to answer information necessary for generating a report indicating an analysis result of the analysis target; a generation control process of inputting a prompt to a machine-learned generation model so as to generate an answer to the input prompt and generating an answer; and a presentation control process of presenting a report indicating an analysis result of the analysis target generated based on the answer.

The information processing device may further include a memory. The memory may store a program for causing the at least one processor to execute each of the processing.

### Supplementary Note D2

The information processing device according to Supplementary Note D1, in which the at least one processor executes a search process of detecting relevant current event information related to the analysis target from a database in which current event information is recorded, and the at least one processor is configured to input, in the generation control process, a prompt including the relevant current event information to the generation model to generate an answer.

### Supplementary Note D3

The information processing device according to Supplementary Note D2, in which the at least one processor is configured to search the relevant current event information every time a predetermined search timing arrives, a new prompt is generated for instructing to answer information necessary for generating a report indicating an analysis result of the analysis target by using the new relevant current event information in a case where the new relevant current event information is detected by the search process, the new prompt is input to the generation model to generate a new answer, and a report updated based on the new answer is presented.

### Supplementary Note D4

The information processing device according to any one of Supplementary Notes D1 to D3, in which the at least one processor executes a verification process of verifying whether a content of an answer generated by the generation model is a fact by collating the answer with collation data whose content has been confirmed to be a fact, and the at least one processor presents, in the presentation control process, a report generated based on an answer whose content is determined to be a fact by the verification process.

### Supplementary Note D5

The information processing device according to Supplementary Note D2, in which the generation model is a language model obtained by machine learning of a natural language, and the at least one processor is configured to: accept feedback in a natural language regarding a content of the presented report; generate a new prompt that includes a content of the feedback and instructs to answer information necessary for generating a report indicating an analysis result of the analysis target; input the new prompt to the generation model to generate a new answer; and present a report updated based on the new answer.

### Supplementary Note D6

The information processing device according to any one of Supplementary Notes D1 to D5, in which the at least one processor is configured to generate, in the prompt generation process, a prompt for instructing to answer a component of a report necessary for generating the report indicating an analysis result of the analysis target, the at least one processor executes a report generation process of generating a report by arranging each component included in an answer generated by the generation control process inputting the prompt to the generation model, and the at least one processor is configured to present, in the presentation control process, the report generated by the report generation process.

### Supplementary Note D7

The information processing device according to Supplementary Note D6, in which the at least one processor is configured to generate, in the prompt generation process, a prompt for instructing to answer a component of a report necessary for generating the report indicating an analysis result of the analysis target and to determine a priority of the component, and the at least one processor is configured to generate, in the report generation process, a report in which the component having a high priority is preferentially arranged.

### Supplementary Note D8

The information processing device according to Supplementary Note D2 or D3, in which the at least one processor executes: a time-series element detection process of detecting a plurality of pieces of relevant current event information on a same target, the plurality of pieces of relevant current event information having different time series, from among a plurality of pieces of relevant current event information detected by the search process; and a transition information generation process of generating transition information indicating a time-series change of the target based on the plurality of pieces of relevant current event information detected by the time-series element detection process, and the at least one processor is configured to present, in the presentation control process, the report including the transition information.

### Supplementary Note E

A non-transitory recording medium having recorded therein an analysis support program for causing a computer to execute: an acceptance process of accepting designation of an analysis target; a prompt generation process of generating a prompt for instructing to answer information necessary for generating a report indicating an analysis result of the analysis target; a generation control process of inputting a prompt to a machine-learned generation model so as to generate an answer to the input prompt and generating an answer; and a presentation control process of presenting a report indicating an analysis result of the analysis target generated based on the answer.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one memory storing instructions; and
at least one processor configured to execute the instructions to:
accept designation of an analysis target;
generate a prompt for instructing to answer information necessary for generating a report indicating an analysis result of the analysis target;
input the prompt to a machine-learned generation model to generate an answer to the input prompt; and
present a report indicating an analysis result of the analysis target generated based on the answer.

2. The information processing apparatus according to claim 1, wherein the at least one processor of the first base station is further configured to execute the instructions to
detect relevant current event information related to the analysis target from a database storing the current event information;
input to the generation model a prompt including the relevant current event information to generate an answer.

3. The information processing apparatus according to claim 2, wherein the at least one processor of the first base station is further configured to execute the instructions to
search the relevant current event information every time a predetermined search timing arrives,
search the relevant current event information each time a predetermined search timing arrives;
generate, in a case where new relevant current event information is detected, a new prompt instructing generation of information necessary for generating a report indicating an analysis result of the analysis target by using the new relevant current event information;
input the new prompt to the generation model to generate a new answer; and
present a report updated based on the new answer.

4. The information processing apparatus according to claim 1, wherein the at least one processor of the first base station is further configured to execute the instructions to
verify whether a content of an answer generated by the generation model is a fact by collating the answer with collation data whose content has been confirmed to be a fact; and
present a report generated based on an answer whose content is determined to be a fact.

5. The information processing apparatus according to claim 2, wherein the at least one processor of the first base station is further configured to execute the instructions to
define the generation model as a language model obtained by machine learning of a natural language;
accept feedback in a natural language regarding a content of the presented report;
generate a new prompt that includes a content of the feedback and instructs to answer information necessary for generating a report indicating an analysis result of the analysis target;
input the new prompt to the generation model to generate a new answer; and
present a report updated based on the new answer.

6. The information processing apparatus according to claim 1, wherein the at least one processor of the first base station is further configured to execute the instructions to
generate a prompt for instructing to answer a component of a report necessary for generating the report indicating an analysis result of the analysis target,
generate a report by arranging each component included in an answer generated by inputting the prompt to the generation model; and
present the report generated by generating the report.

7. The information processing apparatus according to claim 6, wherein the at least one processor of the first base station is further configured to execute the instructions to
generate a prompt instructing to answer a component of a report necessary for generating the report indicating an analysis result of the analysis target and to determine a priority of the component; and
generate a report in which the component having a high priority is preferentially arranged.

8. The information processing apparatus according to claim 2, wherein the at least one processor of the first base station is further configured to execute the instructions to
detect a plurality of pieces of relevant current event information on the same target, the plurality of pieces of relevant current event information having different time series, from among a plurality of pieces of relevant current event information detected by searching; and
generate transition information indicating a time-series change of the target based on the plurality of pieces of relevant current event information detected; and
present the report including the transition information.

9. An analysis support method for causing at least one processor to execute:
an acceptance process of accepting designation of an analysis target;
a prompt generation process of generating a prompt for instructing to answer information necessary for generating a report indicating an analysis result of the analysis target;
a generation control process of inputting a prompt to a machine-learned generation model so as to generate an answer to the input prompt and generating an answer; and
a presentation control process of presenting a report indicating an analysis result of the analysis target generated based on the answer.

10. The analysis support method according to claim 9, wherein
the at least one processor executes a search process of detecting relevant current event information related to the analysis target from a database in which current event information is recorded, and
the at least one processor is configured to input, in the generation control process, a prompt including the relevant current event information to the generation model to generate an answer.

11. The analysis support method according to claim 10, wherein
the at least one processor is configured to search the relevant current event information every time a predetermined search timing arrives,
a new prompt is generated for instructing to answer information necessary for generating a report indicating an analysis result of the analysis target by using the new relevant current event information in a case where the new relevant current event information is detected by the search process,
the new prompt is input to the generation model to generate a new answer, and
a report updated based on the new answer is presented.

12. The analysis support method according to claim 9, wherein
the at least one processor executes a verification process of verifying whether a content of an answer generated by the generation model is a fact by collating the answer with collation data whose content has been confirmed to be a fact, and
the at least one processor presents, in the presentation control process, a report generated based on an answer whose content is determined to be a fact by the verification process.

13. The analysis support method according to claim 10, wherein
the generation model is a language model obtained by machine learning of a natural language, and
the at least one processor is configured to:
accept feedback in a natural language regarding a content of the presented report;
generate a new prompt that includes a content of the feedback and instructs to answer information necessary for generating a report indicating an analysis result of the analysis target;
input the new prompt to the generation model to generate a new answer; and
present a report updated based on the new answer.

14. The analysis support method according to claim 9, wherein
the at least one processor is configured to generate, in the prompt generation process, a prompt for instructing to answer a component of a report necessary for generating the report indicating an analysis result of the analysis target,
the at least one processor executes a report generation process of generating a report by arranging each component included in an answer generated by the generation control process inputting the prompt to the generation model, and
the at least one processor is configured to present, in the presentation control process, the report generated by the report generation process.

15. The analysis support method according to claim 14, wherein
the at least one processor is configured to generate, in the prompt generation process, a prompt for instructing to answer a component of a report necessary for generating the report indicating an analysis result of the analysis target and to determine a priority of the component, and
the at least one processor is configured to generate, in the report generation process, a report in which the component having a high priority is preferentially arranged.

16. The analysis support method according to claim 10, wherein
the at least one processor executes:
a time-series element detection process of detecting a plurality of pieces of relevant current event information on a same target, the plurality of pieces of relevant current event information having different time series, from among a plurality of pieces of relevant current event information detected by the search process; and
a transition information generation process of generating transition information indicating a time-series change of the target based on the plurality of pieces of relevant current event information detected by the time-series element detection process, and
the at least one processor is configured to present, in the presentation control process, the report including the transition information.

17. A non-transitory recording medium having stored therein an analysis support program for causing a computer to function to:
accept designation of an analysis target;
generate a prompt for instructing to answer information necessary for generating a report indicating an analysis result of the analysis target;
input the prompt to a machine-learned generation model to generate an answer to the input prompt; and
present a report indicating an analysis result of the analysis target generated based on the answer.

18. The non-transitory recording medium having stored therein an analysis support program according to claim 17, wherein the computer is caused to:
detect relevant current event information related to the analysis target from a database in which the current event information is recorded; and
input a prompt including the relevant current event information to the generation model to generate an answer.

19. The non-transitory recording medium having stored therein an analysis support program according to claim 18, wherein the computer is caused to:
search the relevant current event information each time a predetermined search timing arrives;
generate a new prompt for instructing to answer information necessary for generating a report indicating an analysis result of the analysis target by using the new relevant current event information upon detecting new relevant current event information;
input the new prompt to the generation model to generate a new answer; and
present a report updated based on the new answer.

20. The non-transitory recording medium having stored therein an analysis support program according to claim 17, wherein the computer is caused to:
verify whether a content of an answer generated by the generation model is a fact by collating the answer with collation data whose content has been confirmed to be a fact; and
present a report generated based on an answer whose content is determined to be a fact.
